(19) United States
(12) Patent Application Publication
(10) Pub. No.: US 2026/0127696 A1
(43) Pub. Date: May 7, 2026

(54) ASSESSING AND ENHANCING SAFETY AND FUNCTIONALITY OF ENVIRONMENTS FOR AGING POPULATIONS

(71) Applicant: Texas State University, San Marcos, TX (US)

(72) Inventors: Mohamad Nadim Adi, San Marcos, TX (US); Mais Aljunaidy, San Marcos, TX (US)

(21) Appl. No.: 19/372,486

(22) Filed: Oct. 29, 2025

Related U.S. Application Data
(60) Provisional application No. 63/714,892, filed on Nov. 1, 2024.

(51) Int. Cl. G06Q 50/26

(52) U.S. Cl. CPC G06Q 50/265

(57) ABSTRACT

A computer-implemented method, system, and computer program product for assessing and enhancing safety and functionality of environments for aging populations. A description of the physical characteristics of an environment (e.g., aging and senior care environments) is received. Such a description includes a comprehensive set of quantifiable and observable data points that define the physical, sensory, and spatial attributes of the space of the environment. Upon receiving the description of physical characteristics of an environment, the description is analyzed against a set of environment design rules (structured guidelines and criteria used to systematically arrange, specify, or modify physical and spatial characteristics of the environment to optimize its safety, functionality, accessibility, and psychological impact for a specified group) tailored for aging populations and individuals with cognitive impairment. Upon performing such an analysis, one or more recommendations for modifying the environment are then generated based on the analysis.

### TECHNICAL FIELD

The present disclosure relates generally to tools for assessing environments for aging populations, and more particularly to assessing and enhancing safety and functionality of environments for aging populations.

### BACKGROUND

The global population is rapidly aging, leading to an increased demand for living environments (e.g., aging and senior care environments) that support independence, safety, and cognitive well-being. A critical challenge within this demographic shift is the design and management of spaces for older adults, particularly the estimated 50 million people worldwide living with dementia or Alzheimer's disease.

One of the problems in current aging and senior care environments is high risk of injury and falls. Falls are the leading cause of injury and death among older adults. Many environments, including homes, assisted living facilities, and hospitals, possess subtle design flaws that become major safety hazards for people with age-related changes in vision, depth perception, balance, and gait. Standard features, such as shiny, patterned floors, poor lighting, or confusing transitions are often overlooked but are significant contributors to fall-related incidents, leading to increased healthcare costs, reduced quality of life, and accelerated decline.

Another problem in current aging and senior care environments is cognitive distress and disorientation. Individuals with cognitive impairments, such as dementia, rely heavily on their environment for orientation, memory cues, and maintaining calm. Current design practices often fail to meet these unique cognitive needs resulting in environments that are stressful, confusing, and disorienting.

Currently, tools used to assess such environments in an attempt to address such complex issues are deficient. For example, existing tools fail to adequately assess such environments to address such complex issues by implementing static guidelines. Current dementia-friendly or aging-in-place design guidelines are typically static, lengthy, and abstract documents. They offer general principles but do not provide the room-by-room, actionable, and personalized feedback needed to evaluate a specific, existing environment.

In another example, existing tools focus on single issues. For example, most existing assessment tools or technologies focus on isolated components, such as non-slip flooring, emergency response systems (e.g., fall-detection technology), or general building code compliance. They fail to integrate the holistic set of environment factors critical for cognitive and physical safety (e.g., lighting, color contrast, wayfinding, and memory aids) into one unified analysis.

In a further example, existing tools lack evidence-based practicality. There is a disconnect between academic research on dementia-friendly design and its practical application in the field. Professionals (e.g., architects, interior designers, facility managers, caregivers, etc.) require a tool that synthesizes this latest evidence into quantifiable, user-friendly assessments that offer specific, research-backed recommendations (e.g., precise light reflective value (LRV) percentages or optimal signage placement).

Accordingly, there is a need for a comprehensive, evidence-based, and easy-to-use assessment tool that can proactively identify and correct environment hazards thereby reducing injury risks and promoting the independent living and psychological well-being of aging populations, especially those with cognitive decline.

### SUMMARY

In one embodiment of the present disclosure, a computer-implemented method for assessing and enhancing safety and functionality of environments for aging populations comprises receiving a description of physical characteristics of an environment. The method further comprises analyzing the description of physical characteristics of the environment against a set of environment design rules tailored for aging populations and individuals with cognitive impairment, where the set of environment design rules is structured guidelines and criteria used to systematically arrange, specify, or modify physical and spatial characteristics of the environment to optimize its safety, functionality, accessibility, and psychological impact for a specified group. The method additionally comprises generating one or more recommendations for modifying the environment based on the analysis, where the one or more recommendations enhance safety and functionality of the environment by adjusting one or more of the following: wayfinding elements, visual cues, color contrast and visibility, and lighting conditions.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 is a diagram of the software components used by the computer to assess and enhance safety and functionality of environments for aging populations in accordance with an embodiment of the present disclosure;

FIG. 3 illustrates an example of color contrast enhancements in the form of a diagram illustrating the contrast between tableware and surfaces to aid recognition during dining in accordance with an embodiment of the present disclosure;

FIG. 4 illustrates a wayfinding signage that includes a high-contrast signage positioned between 1.2 meters-1.4 meters from the ground with large font sizes for the text and image to provide easy navigation in accordance with an embodiment of the present disclosure;

FIG. 5 illustrates the placement of memory boxes near a doorway to assist individuals with memory recall in accordance with an embodiment of the present disclosure; and

FIG. 6 is a flowchart of a method for assessing and enhancing safety and functionality of environments for aging populations in accordance with an embodiment of the present disclosure.

### DETAILED DESCRIPTION

As stated above, one of the problems in current aging and senior care environments is high risk of injury and falls. Falls are the leading cause of injury and death among older adults. Many environments, including homes, assisted living facilities, and hospitals, possess subtle design flaws that become major safety hazards for people with age-related changes in vision, depth perception, balance, and gait. Standard features, such as shiny, patterned floors, poor lighting, or confusing transitions are often overlooked but are significant contributors to fall-related incidents, leading to increased healthcare costs, reduced quality of life, and accelerated decline.

Another problem in current aging and senior care environments is cognitive distress and disorientation. Individuals with cognitive impairments, such as dementia, rely heavily on their environment for orientation, memory cues, and maintaining calm. Current design practices often fail to meet these unique cognitive needs resulting in environments that are stressful, confusing, and disorienting.

Currently, tools used to assess such environments in an attempt to address such complex issues are deficient. For example, existing tools fail to adequately assess such environments to address such complex issues by implementing static guidelines. Current dementia-friendly or aging-in-place design guidelines are typically static, lengthy, and abstract documents. They offer general principles but do not provide the room-by-room, actionable, and personalized feedback needed to evaluate a specific, existing environment.

In another example, existing tools focus on single issues. For example, most existing assessment tools or technologies focus on isolated components, such as non-slip flooring, emergency response systems (e.g., fall-detection technology), or general building code compliance. They fail to integrate the holistic set of environment factors critical for cognitive and physical safety (e.g., lighting, color contrast, wayfinding, and memory aids) into one unified analysis.

In a further example, existing tools lack evidence-based practicality. There is a disconnect between academic research on dementia-friendly design and its practical application in the field. Professionals (e.g., architects, interior designers, facility managers, caregivers, etc.) require a tool that synthesizes this latest evidence into quantifiable, user-friendly assessments that offer specific, research-backed recommendations (e.g., precise light reflective value (LRV) percentages or optimal signage placement).

Accordingly, there is a need for a comprehensive, evidence-based, and easy-to-use assessment tool that can proactively identify and correct environment hazards thereby reducing injury risks and promoting the independent living and psychological well-being of aging populations, especially those with cognitive decline.

The embodiments of the present disclosure provide a means for effectively assessing and enhancing safety and functionality of environments for aging populations. In one embodiment, a description of the physical characteristics of an environment (e.g., aging and senior care environments) is received. Such a description, as used herein, refers to a comprehensive set of quantifiable and observable data points that define the physical, sensory, and spatial attributes of the space of the environment. In one embodiment, such a description is obtained via direct human observation/measurement (e.g., a checklist audit) or sensing technology. For example, the description of the physical characteristics may include features related to mobility, stability, and perception; data points critical for visual acuity and defining spatial boundaries; measurements impacting depth perception, shadows, and overall illumination; data used for orientation and reducing confusion; and characteristics related to comfort, accessibility, and safety.

Upon receiving the description of physical characteristics of an environment, the description is analyzed against a set of environment design rules tailored for aging populations and individuals with cognitive impairment. The set of environment design rules, as used herein, refers to structured guidelines and criteria used to systematically arrange, specify, or modify physical and spatial characteristics of the environment to optimize its safety, functionality, accessibility, and psychological impact for a specified group (e.g., individuals living with dementia). For example, such an analysis may involve determining a light reflective value contrast between at least two adjacent surfaces within the environment using the description of the physical characteristics of the environment. The determined light reflective value contrast is then compared against a threshold value specified in the set of environment design rules for particular features (e.g., doorways, handrails, bathroom fixtures) to identify deficiencies in visibility. In another example, flooring characteristics in the description of the physical characteristics of the environment, including pattern complexity, reflectivity, and non-slip rating, are analyzed against the set of environment design rules. The consistency of flooring transitions across different areas of the environment to minimize perceived hazards for individuals with depth perception issues is then determined based on such an analysis.

Upon analyzing the description of physical characteristics of an environment against a set of environment design rules tailored for aging populations and individuals with cognitive impairment, one or more recommendations for modifying the environment based on the analysis are then generated. For example, such recommendations enhance safety and functionality of the environment by adjusting wayfinding elements, visual cues, color contrast and visibility, and lighting conditions. For instance, a recommendation may be directed to adjusting a type or location of a lighting fixture to achieve a consistent, shadow-minimizing illumination.

In this manner, the principles of the present disclosure provide a comprehensive, evidence-based, and easy-to-use assessment tool that can proactively identify and correct environment hazards thereby reducing injury risks and promoting the independent living and psychological well-being of aging populations, especially those with cognitive decline. A further discussion regarding these and other features is provided below.

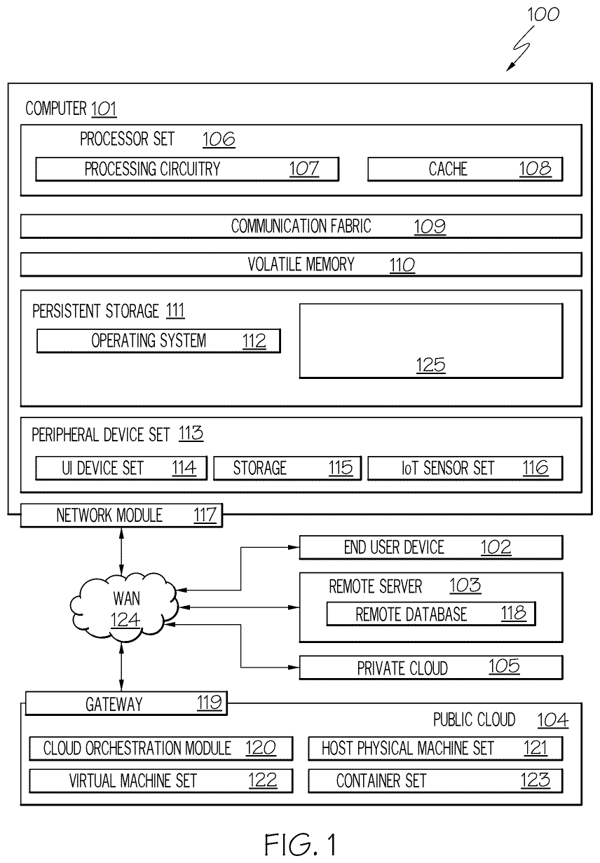

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as assessing and enhancing safety and functionality of environments for aging populations. In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

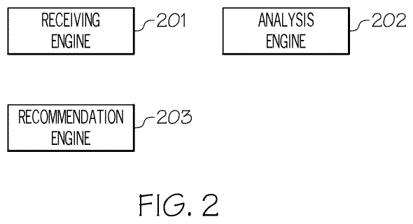

Block 125 further includes the software components discussed herein in connection with FIGS. 2-5 to assess and enhance safety and functionality of environments for aging populations. In one embodiment, such components may be implemented in hardware. The functions discussed herein performed by such components are not generic computer functions. As a result, computer 101 is a particular machine that is the result of implementing specific, non-generic computer functions.

In one embodiment, the functionality of such software components of computer 101, including the functionality for assessing and enhancing safety and functionality of environments for aging populations, may be embodied in an application specific integrated circuit.

A further discussion regarding the functionality of the components used by computer 101 to assess and enhance safety and functionality of environments for aging populations is provided below in connection with FIG. 2.

FIG. 2 is a diagram of the software components used by computer 101 to assess and enhance safety and functionality of environments for aging populations in accordance with an embodiment of the present disclosure.

Referring to FIG. 2, in conjunction with FIG. 1, computer 101 includes receiving engine 201 configured to receive a description of physical characteristics of an environment, such as an environment for aging and senior care. Such a description, as used herein, refers to a comprehensive set of quantifiable and observable data points that define the physical, sensory, and spatial attributes of the space of the environment. In one embodiment, such a description is obtained via direct human observation/measurement (e.g., a checklist audit) or sensing technology. For example, the description of the physical characteristics may include features related to mobility, stability, and perception; data points critical for visual acuity and defining spatial boundaries; measurements impacting depth perception, shadows, and overall illumination; data used for orientation and reducing confusion; and characteristics related to comfort, accessibility, and safety.

In one embodiment, the description of the physical characteristics includes, but not limited to, the following categories: surface and flooring, color contrast and visibility, lighting conditions, wayfinding (spatial problem-solving process used by people to navigate from one location to another, relying on cognitive maps, environment cues, and directional information) and spatial organization, furnishings and fixtures.

In the category of surface and flooring, the physical characteristics include features related to mobility, stability, and perception. Examples of such physical characteristics include non-slip rating (coefficient of friction of flooring), pattern complexity (a description (e.g., solid, small, repetitive, large geometric) or a calculated metric of visual complexity, reflectivity (measurement of floor, wall, and surface gloss/sheen (potential for glare)), and transitions (presence/absence of thresholds, ramps, or changes in floor material between rooms).

In the category of color contrast and visibility, the physical characteristics include data points critical for visual acuity and defining spatial boundaries. Examples of such physical characteristics include the light reflective value (LRV), such as a measured LRV of adjacent surfaces (e.g., wall versus handrail, toilet seat versus bathroom floor, tableware versus dinning surface), and fixture visibility (color contrast ratios for essential elements (e.g., grab bars, door frames) against their background).

In the category of lighting conditions, the physical characteristics include measurements impacting depth perception, shadows, and overall illumination. Examples of such physical characteristics include ambient light levels (measured illuminance, such as in lux or foot-candles, in key areas (e.g., corridors, bedrooms, bathrooms)), shadow potential (e.g., identification of specific light sources (e.g., downlights) that create harsh or confusing shadows), and glare sources (e.g., presence of unprotected windows or highly reflective surfaces causing visual distress).

In the category of wayfinding and spatial organization, the physical characteristics include data used for orientation and reducing confusion. Examples of such physical characteristics include signage attributes (e.g., font size, color contrast, use of imagery/pictograms, and physical height/placement from the floor), landmarks (e.g., location and description of unique or recognizable features (e.g., furniture arrangement, artwork) used for cognitive mapping), and door/room identification (e.g., method of labeling doors and proximity to personalized memory cues (e.g., memory boxes)).

In the category of furnishings and fixtures, the physical characteristics include characteristics related to comfort, accessibility, and safety. Examples of such physical characteristics include handrail placement (e.g., height, diameter, and continuity of handrails in corridors and stairwells), accessibility (e.g., presence and location of grab bars in showers and near toilets), and seating contrast (e.g., color contrast of upholstery relative to the floor or surrounding walls to aid recognition).

In one embodiment, receiving engine 201 receives a description of the physical characteristics of the environment (e.g., environment for aging and senior care) through several means, including direct input, data capture, and external integration.

In one embodiment, a user (e.g., architect, facility manager, caregiver) directly enters the data (description of the physical characteristics of the environment) into computer 101.

In one embodiment, receiving engine 201 utilizes structured forms and checklists to obtain the description of the physical characteristics of the environment. For example, receiving engine 201 presents a digital form (e.g., a web application, desktop software, or mobile app) with fields corresponding to the required physical characteristics. The user manually inputs the data. For instance, a checklist for a room may include fields, such as flooring type: (dropdown: “Carpet,” “Hardwood,” “Tile”), lighting type: (dropdown: “Natural,” “Fluorescent,” “LED”), color contrast LRV: (numeric input), handrail placement: (Boolean: “Yes/No”), and doorway width: (numeric input).

In another example of utilizing structured forms and checklists to obtain the description of the physical characteristics of the environment, receiving engine 201 implements an interactive floor plan tool. For instance, the user may upload a floor plan and use an interactive overlay tool to “tag” or draw in specific features, such as handrail locations, fixture types, or areas of poor lighting.

In one embodiment, receiving engine 201 receives a description of the physical characteristics of the environment via data capture and processing. For example, receiving engine 201 utilizes image/video processing to obtain the description of the physical characteristics of the environment. For instance, in one embodiment, the user uploads photographs or video of the environment to computer 101. Receiving engine 201 then uses image recognition algorithms to identify, categorize, and measure the physical features. For example, receiving engine 201 may detect the presence of a grab bar in a bathroom, measure the color contrast between the toilet seat and the floor, or assesses the uniformity of lighting.

Another example of using data capture and processing to obtain a description of the physical characteristics of the environment is utilizing 3D scanning and building information modeling (BIM) integration. In such an embodiment, receiving engine 201 receives data directly from 3D laser scans or building information modeling (BIM) files. These files contain highly detailed, measured data on geometry, materials, and components. For example, in one embodiment, receiving engine 201 obtains precise measurements of room dimensions, wall textures, fixture locations, and window sizes via the use of a BIM model.

In one embodiment, receiving engine 201 receives a description of the physical characteristics of the environment via external data integration. In one embodiment, external data integration involves pulling existing data from outside sources or databases. For instance, in one embodiment, receiving engine 201 obtains a description of the physical characteristics of the environment via API (application programming interface) integration with design software. For example, receiving engine 201 connects to the APIs of architectural or interior design software to pull the relevant data from the design files.

Another example of using external data integration to obtain a description of the physical characteristics of the environment is utilizing sensor data. In one embodiment, receiving engine 201 receives real-time or recorded data from IoT devices, such as light meters to measure the actual light levels (lux) in various area, sound sensors to assess ambient noise for calmness criteria, and temperature/humidity sensors for comfort and safety assessment.

In one embodiment, receiving engine 201 utilizes a data ingestion module that validates and structures the incoming data into a standardized format (e.g., JSON or XML) before it is passed to analysis engine 202, which applies the “set of environment design rules” as discussed further below.

Computer 101 further includes analysis engine 202 configured to analyze the description of physical characteristics of the environment against a set of environment design rules tailored for aging populations and individuals with cognitive impairment. The set of environment design rules, as used herein, refers to structured guidelines and criteria used to systematically arrange, specify, or modify physical and spatial characteristics of the environment to optimize its safety, functionality, accessibility, and psychological impact for a specified group (e.g., individuals living with dementia).

For example, such an analysis may involve determining a light reflective value contrast between at least two adjacent surfaces within the environment using the description of the physical characteristics of the environment. The determined light reflective value contrast is then compared against a threshold value specified in the set of environment design rules for particular features (e.g., doorways, handrails, bathroom fixtures) to identify deficiencies in visibility.

In another example, flooring characteristics in the description of the physical characteristics of the environment, including pattern complexity, reflectivity, and non-slip rating, are analyzed against the set of environment design rules. The consistency of flooring transitions across different areas of the environment to minimize perceived hazards for individuals with depth perception issues is then determined based on such an analysis.

In one embodiment, prior to analysis engine 202 performing such an analysis, the set of environment design rules tailored for aging populations and individuals with cognitive impairment is defined and structured.

In one embodiment, the “set of environment design rules” is codified based on wayfinding/visibilty, color contrast, lighting, and safety. For example, based on wayfinding/visibility, the rule category may correspond to signage and visual cues. An exemplary coded rule (logic) for such a rule category is IF Signage_Contrast_LRV<70%, THEN FAIL, where Signage_Contrast_LRV refers to the light reflective value (LRV) difference between the signage itself (e.g., letters, symbols, or graphics) and its background. An example of a failed compliance output using such a coded rule (logic) is when the signage contrast is too low for impaired vision.

In another example, the set of environment design rules is codified based on color contrast. For example, based on color contrast, the rule category may correspond to fixtures and surfaces. An exemplary coded rule (logic) for such a rule category is IF Tableware_Color≈Surface_Color THEN FAIL. Tableware_Color≈Surface_Color refers to the comparison of the color and, more critically, the light reflective value (LRV) contrast between dining items (tableware) and the surface they rest on (tabletop or tray). An example of a failed compliance output using such a coded rule (logic) is when the visual contrast between the tableware (plates, cups, bowls) and the dining surface (tabletop or placemat) is too low.

In a further example, the set of environment design rules is codified based on lighting. For example, based on lighting, the rule category may correspond to glare and shadows. An exemplary coded rule (logic) for such a rule category is IF Lighting_Uniformity≤Threshold AND Reflective Floor=TRUE THEN FAIL. Lighting_Uniformity is a metric used to assess how evenly light is distributed across a defined area, such as a room, hallway, or walkway. Reflective_Floor=TRUE is a Boolean variable state within the analysis that indicates the floor surface of the environment being assessed is highly glossy, polished, or otherwise highly reflective. An example of a failed compliance output using such a coded rule (logic) is when there is a combination of uneven lighting and reflective flooring that creates confusing shadows/glare.

In another example, the set of environment design rules is codified based on safe flooring. For example, based on safe flooring, the rule category may correspond to flooring. An exemplary coded rule (logic) for such a rule category is IF Flooring_Pattern=“Complex” OR Flooring_Slickness≥Threshold THEN FAIL. The condition IF Flooring_Pattern=“Complex” means that analysis engine 202 is checking whether the floor surface of the environment has a visually busy, high-contrast, or non-uniform design. The condition Flooring_Slickness≥Threshold means that analysis engine 202 has determined the floor surface is too slippery (possesses a high degree of slickness or a low coefficient of friction) to be considered safe for an aging population. An example of a failed compliance output using such a coded rule (logic) is when the patterned flooring can cause visual confusion and increase fall risk.

In a further example, the set of environment design rules is codified based on bathroom safety. For example, based on bathroom safety, the rule category may correspond to fixtures. An exemplary coded rule (logic) for such a rule category is IF Grab_Bars_Present=FALSE OR Toilet_Seat_Contrast=Low THEN FAIL. The condition IF Grab_Bars_Present=FALSE means analysis engine 202 has determined that grab bars are not installed or are not present in the bathroom area of the environment being assessed. The condition Toilet_Seat_Contrast=Low means analysis engine 202 has determined there is insufficient visual contrast between the toilet seat and the surrounding area, particularly the toilet bowl or the wall behind it. An example of a failed compliance output using such a coded rule (logic) is when there are missing grab bars or a high-contrast toilet seat is needed for visibility.

In one embodiment, analysis engine 202 processes the received description (from forms, BIM, or sensors) and normalizes it into standardized data variables (e.g., Signage_Contrast_LRV, Doorway_Width, Lighting_Uniformity). Analysis engine 202 then runs the standardized input data through every relevant coded rule in the “set of environment design rules.” In one embodiment, each rule check results in an outcome (e.g., pass, fail, caution) and an associated score for that element. In one embodiment, analysis engine 202 aggregates these scores to create a sectional safety score (e.g., a wayfinding score, a bathroom safety score) and an overall compliance score.

In one embodiment, after codifying the design rules, analysis engine 202 performs the analysis of the description of the physical characteristics of the environment against the set of environment design rules tailored for aging populations and individuals with cognitive impairment in two stages, namely data mapping and calculation as well as rule comparison and scoring.

In one embodiment, data mapping and calculation involves analysis engine 202 mapping the received data (description of the physical characteristics) to the standardized variables used in the rules. For example, analysis engine 202 maps the measured LRVs of the sign and the background to calculate the Signage_Contrast_LRV.

In one embodiment, rule comparison and scoring involves analysis engine 202 running the standardized variables through the coded rules. In one embodiment, analysis engine 202 performs iterative checks. For example, analysis engine 202 performs a systematic check for every rule. If the input data violates a rule, then that element receives a “fail” status.

Furthermore, in one embodiment, rule comparison and scoring involves analysis engine 202 generating a compliance score. For example, based on the number and severity of “fails,” analysis engine 202 calculates a compliance score and individual scores for the categories (e.g., a “wayfinding score”).

Additionally, in one embodiment, rule comparison and scoring involves analysis engine 202 performing hazard identification. For example, analysis engine 202 identifies where confusing shadows/glare (e.g., lighting/reflective flooring), visual confusion (e.g., patterned flooring), and fall risks (e.g., slickness/missing grab bars) exist in the environment.

In one embodiment, analysis engine 202 assigns a weighted score to the environment for each safety category (e.g., wayfinding, color contrast, and lighting) based on a predefined weighting scheme derived from clinical or design research. In one embodiment, analysis engine 202 calculates a single, composite score by aggregating the weighted score. As discussed further below, recommendation engine 203 generates a recommendation(s) for modifying the environment based on the single, composite score.

In one embodiment, analysis engine 202 defines the metrics within the safety categories (e.g., wayfinding, color contrast, lighting). For example, for the wayfinding safety category, the metrics of the number of clear signage locations, clarity index of directional text, logical flow score, etc. are measured. In another example, for the color contrast safety category, the average luminance contrast ratio of key elements (e.g., floor to wall), color difference score, etc. are measured. In a further example, for the lighting safety category, the average illuminance (lux) levels in key areas, uniformity ratio, glare rating, etc. are measured.

In one embodiment, each of these metrics is associated with a defined measurement scale and a target/ideal value.

In one embodiment, analysis engine 202 standardizes/normalizes the raw scores. For example, analysis engine 202 converts the raw measurement score (e.g., illuminance=500 lux) from the environment into a standardized score (e.g., 0 to 1 or 0 to 100), where a higher score indicates better performance relative to the ideal. For example, with respect to color contrast, if the ideal LCR is 7:1 or higher, and the minimum acceptable is 3:1, a function may be utilized to assign 100 for 7:1 and above, 0 for 3:1 and below, and scales linearly in between.

In another example, with respect to lighting, if the target illuminance is 500 lux, a deviation of ±100 lux might result in a score reduction.

In one embodiment, this standardization results in a category metric score (Sₘ) for each metric, ranging from [0, 1] or [0, 100].

In one embodiment, analysis engine 202 calculates a score for each main safety category by aggregating the scores of its constituent metrics using predefined internal weights (wₘ). In one embodiment, the category score (CS_{c}) for category c is the weighted average of its metric scores (S_{m,i})

$${CS}_{c} = \frac{{\sum }_{i = 1}^{n} ( {S}_{m , i} \cdot {w}_{m , i} )}{{\sum }_{i = 1}^{n} {w}_{m , i}}$$

For example, in the wayfinding category, if the number of clear signage locations is considered twice as important as the clarity index, its weight (wₘ) would be 2 and the other 1.

In one embodiment, the predefined weighting scheme assigns an external weight (W_{c}) to each category, derived from clinical or design research. These weights reflect the relative importance of each category to overall safety. For example, the wayfinding safety category may be assigned the weight (W_{c}) of 0.35 based on studies on cognitive decline and disorientation. Furthermore, the color contrast safety category may be assigned the weight (W_{c}) of 0.45 based on vision impairment and fall prevention research. In another example, the lighting safety category may be assigned the weight (W_{c}) of 0.20 based on research on visual acuity and depression in aging.

In one embodiment, analyzing engine 202 calculates the weighted score for the environment for each safety category:

$$Weighted Score = {CS}_{c} \cdot {W}_{c}$$

In one embodiment, analysis engine 202 aggregates the weighted scores from all categories to calculate the final composite score (CompS). In one embodiment, the final composite score is a single number that represents the environment's overall safety rating.

$$CompS = {\sum }_{c = 1}^{k} Weighted {Score}_{c} = {\sum }_{c = 1}^{k} ( {CS}_{c} \cdot {W}_{c} )$$

In one embodiment, both the category scores ((CS_{c}) and the final composite score are on a [0, 100] scale. In such an embodiment, a score of 95, for example, means the environment meets 95% of the weighted safety criteria.

In one embodiment, analysis engine 202 utilizes the following key design principles and features that form the foundation of the tool of the present disclosure, which reduces injury risks and promotes the independent living and psychological well-being of aging populations, especially those with cognitive decline. Such principles and features form the ruleset and assessment criteria used by analysis engine 202 for translating research on gerontology, vision impairment, and dementia care into actionable design standards. The approach is holistic, covering the environment from the macro level (wayfinding) to the micro level (tableware contrast).

In one embodiment, one key design principle and feature is safety and visibility through contrast. For example, high visual contrast is used to compensate for age-related and cognitive visual impairments. Examples of safety and visibility through contrast include color contrast and visibility, which mandates clear distinctions between objects to prevent confusion. For instance, analyzing engine 202 analyzes the physical characteristics of the environment against the set of environment design rules to ensure a user-designated high contrast between tableware and surfaces to aid recognition during dining and ensures essential features, such as handrails and door frames, are clearly visible against their backgrounds.

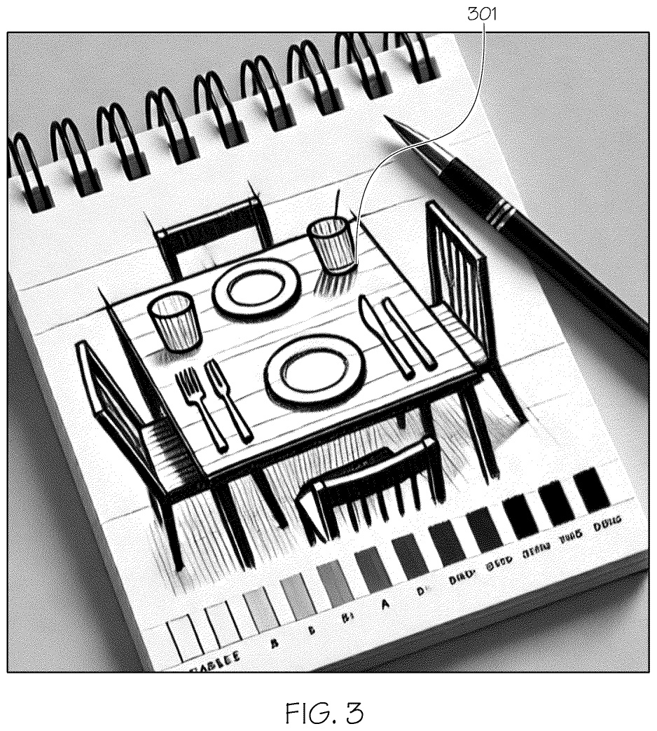

An example of color contrast enhancements used to emphasize the contrast between tableware and surfaces to aid recognition during dining is shown in FIG. 3.

Referring to FIG. 3, FIG. 3 illustrates an example of color contrast enhancements in the form of a diagram 301 illustrating the contrast between tableware and surfaces to aid recognition during dining in accordance with an embodiment of the present disclosure.

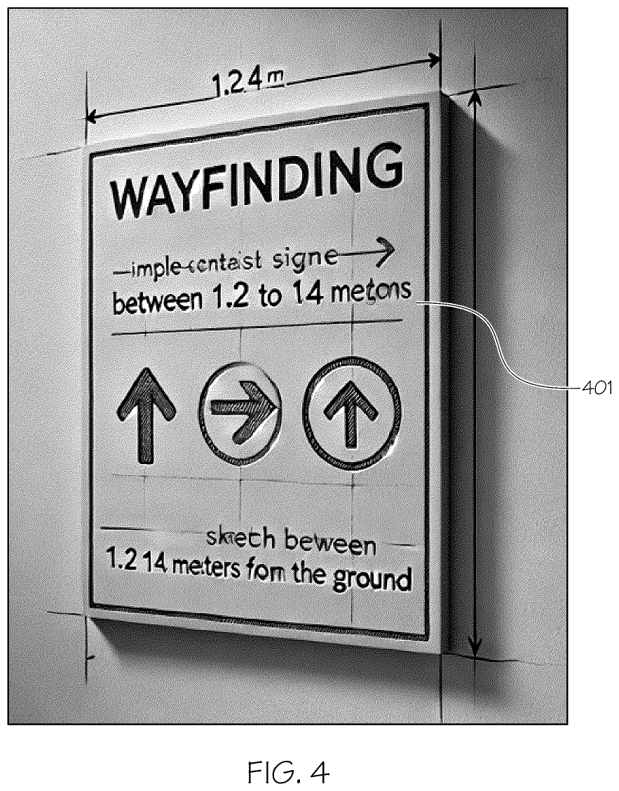

Another example of safety and visibility through contrast includes wayfinding and navigation. For example, contrast may be optimized by requiring a minimum light reflective value (LRV) difference for key features, such as signage and doorways. As a result, analyzing engine 202 analyzes the physical characteristics of the environment against the set of environment design rules to ensure such a minimum LRV difference for key features is obtained. In another example, signage may be positioned at eye level (from the ground) and include large font sizes for maximum legibility As a result, analyzing engine 202 analyzes the physical characteristics of the environment against the set of environment design rules to ensure that the signage is appropriate. An example of wayfinding signage being used to promote safety and visibility through contrast is provided in FIG. 4.

Referring to FIG. 4, FIG. 4 illustrates a wayfinding signage 401 that includes a high-contrast signage positioned between 1.2 meters-1.4 meters from the ground with large font sizes for the text and image to provide easy navigation in accordance with an embodiment of the present disclosure.

A further example of safety and visibility through contrast includes handrails and stair safety. Handrails need to be in clear contrast with surrounding walls, and color strips are used on stairs to signal level transitions, both aimed at assisting orientation and preventing falls. As a result, analyzing engine 202 analyzes the physical characteristics of the environment against the set of environment design rules to ensure that handrails are in clear contrast with surrounding walls and that color strips are used on stairs to signal level transitions.

In one embodiment, another key design principle and feature is fall prevention and environment clarity. Such a principle focuses on mitigating physical hazards and reducing visual confusion that leads to falls. For example, analyzing engine 202 analyzes the physical characteristics of the environment against the set of environment design rules to ensure safe flooring and pathways. Such an analysis is important for preventing falls by individuals by ensuring that the flooring be non-slip, pattern-free, and non-reflective. Furthermore, by ensuring that the flooring is pattern-free and non-reflective, this avoids visual confusion, which is often caused when shiny or patterned surfaces are misinterpreted as water, holes, or uneven ground by individuals with dementia.

In another embodiment, fall prevention and environment clarity is achieved by analyzing engine 202 analyzing the physical characteristics of the environment against the set of environment design rules to ensure lighting is appropriate. For example, analyzing engine 202 analyzes the physical characteristics of the environment against the set of environment design rules to ensure there is consistent, natural lighting thereby promoting safe navigation by eliminating the shadows that confuse individuals with depth perception issues. It also stresses that glare should be minimized, directly linking lighting quality to safety.

In another embodiment, fall prevention and environment clarity is achieved by analyzing engine 202 analyzing the physical characteristics of the environment against the set of environment design rules to ensure adequate bathroom safety. For example, analyzing engine 202 combines contrast with accessibility to ensure adequate bathroom safety, such as ensuring there are grab bars (e.g., grab bars in showers and near toilets) and non-slip flooring while also ensuring contrasting toilet seats to enhance fixture visibility.

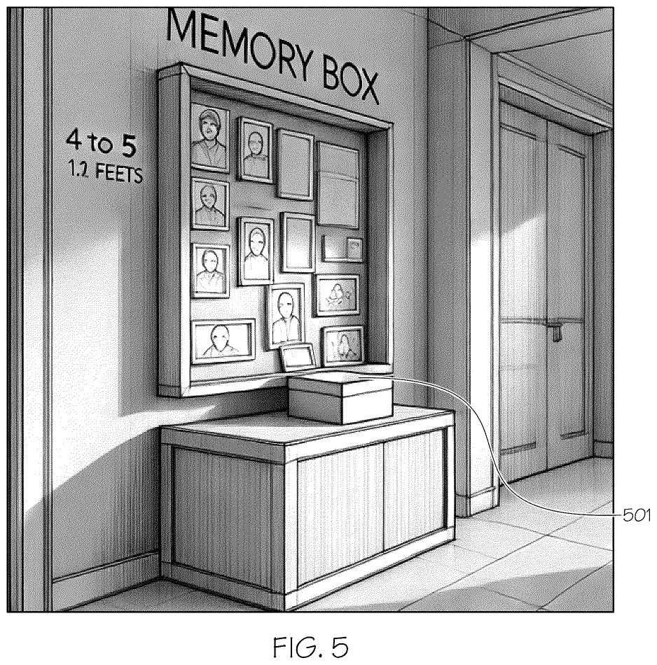

In one embodiment, another key design principle and feature is cognitive and emotional support. Such a design rule addresses the psychological impact of the environment for individuals, such as individuals with dementia. For example, analyzing engine 202 analyzes the physical characteristics of the environment against the set of environment design rules to ensure comfort and reducing anxiety by ensuring the existence of memory aids and personalization. Such a principle emphasizes integrating personalized visual cues, such as memory boxes or personal photographs near doorways, to assist with orientation and memory recall thereby increasing comfort and reducing anxiety. For example, analyzing engine 202 may ensure that a memory box, which may be personalized with an individual's family photographs and memorabilia, is placed near a doorway to assist the individual with orientation and memory recall. An example of the placement of memory boxes near a doorway to assist individuals (individuals with personalized memories contained in such memory boxes) with memory recall is provided in FIG. 5.

FIG. 5 illustrates the placement of memory boxes 501 near a doorway to assist individuals (individuals with personalized memories contained in such memory boxes) with memory recall in accordance with an embodiment of the present disclosure.

In another embodiment, cognitive and emotional support is achieved by analyzing engine 202 analyzing the physical characteristics of the environment against the set of environment design rules to ensure calmness. For example, analyzing engine 202 analyzes the physical characteristics of the environment against the set of environment design rules to ensure calmness in the environment, such as ensuring that calming, soft colors (e.g., warm white or cool blue colors) are used on the walls to reduce agitation and create a soothing atmosphere based on the direct link between the environment and psychological well-being.

As a result of implementing such design principles and features, the principles of the present disclosure provide a comprehensive, evidence-based, and highly specialized system that moves beyond general safety checklists to provide quantifiable, actionable design guidance tailored precisely to the unique cognitive and physical needs of the aging population.

Computer 101 further includes recommendation engine 203 configured to generate one or more recommendations for modifying the environment based on the analysis performed by analyzing engine 202, where the recommendations enhance safety and functionality of the environment by adjusting wayfinding elements, visual cues, color contrast and visibility, and/or lighting conditions. For instance, a recommendation may be directed to adjusting a type or location of a lighting fixture to achieve a consistent, shadow-minimizing illumination.

In one embodiment, such recommendations are actionable insights designed to enhance the environment's safety, accessibility, and functionality. They translate the identified deficiencies (e.g., poor color contrast, inadequate lighting, complex flooring) into concrete, practical corrective actions.

In one embodiment, the modifications to the environment are specifically aimed at adjusting key environment factors, such as wayfinding elements, visual cues and memory aids, color contrast and visibility, lighting conditions, and flooring and pathways. For example, with respect to wayfinding elements, recommendation engine 203 generates a recommendation for high-contrast, appropriately sized, and well-placed signage (e.g., positioned at eye level, using a minimum light reflective value (LRV) contrast of 70% for visibility). In another example, with respect to visual cues and memory aids, recommendation engine 203 generates a recommendation for the strategic placement of personalized cues, such as memory boxes or personal photographs, at specific locations, such as doorways, within the environment to assist with orientation and memory recall. In a further example, with respect to color contrast and visibility, recommendation engine 203 generates a recommendation to ensure a high contrast between essential features and their background (e.g., between handrails and walls, tableware and surfaces, or toilet seats and bathroom floors) to aid recognition for individuals with vision or cognitive impairment. In another example, with respect to lighting conditions, recommendation engine 203 generates a recommendation for adjusting the type or location of lighting fixtures to achieve consistent, natural, and shadow-minimizing illumination while also minimizing glare. In a further example, with respect to flooring and pathways, recommendation engine 203 generates a recommendation for using non-slip, non-reflective, and pattern-free flooring, and corrective actions to ensure consistent floor transitions to minimize perceived fall hazards. In another example, with respect to targeted corrective action, when the analysis involves assigning weighted scores and calculating a composite score, recommendation engine 203 generates a recommendation that includes a specific corrective action corresponding to any safety category (wayfinding, color contrast/lighting) that falls below a predetermined safety threshold. In a further example, with respect to proactive hazard prevention, recommendation engine 203 generates a proactive recommendation which identifies potential hazards in the physical space before an accident occurs thereby directly contributing to the intended purpose of reducing fall-related incidents and confusion in the aging population.

In one embodiment, recommendation engine 203 uses the analysis data from analysis engine 203 to formulate recommendations within specified constraints. In one embodiment, recommendation engine 203 identifies deficiencies. For example, recommendation engine 203 scans the analysis to pinpoint areas that fall short of established safety/accessibility standards (e.g., ADA guidelines, building codes, industry best practices) or operational goals (e.g., minimizing errors, speeding up task completion). For example, the analysis performed by analysis engine 202 indicates a low lex level in the main corridor.

In one embodiment, for each identified deficiency, recommendation engine 203 identifies the recommendation to address the identified deficiency based on performing a look-up in a data structure (e.g., table) that contains a listing of recommendations based on identified deficiencies. Upon identifying the deficiency, recommendation engine 203 performs a look-up in the data structure to identify the recommendation associated with the identified deficiency. In one embodiment, such a data structure is populated by an expert (e.g., administrator, architect, interior designer, facility manager). In one embodiment, the data structure resides within the storage device (e.g., storage device 113, 115) of computer 101.

In one embodiment, recommendation engine 203 generates a specific, quantifiable action that directly addresses the deficiency using one of the allowed adjustments to enhance safety and functionality. For example, recommendation engine 203 generates a recommendation that increases the lighting condition in the main corridor to a uniform lux level by replacing existing fixtures with higher-output LED panels (enhances functionality for task visibility and safety by reducing tripping hazards).

In one embodiment, as discussed above, recommendation engine 203 generates a recommendation(s) for modifying the environment based on the single, composite score. For example, the data structure discussed above may contain a listing of recommendations to be performed to address the identified deficiency, where each recommendation is associated with a range of values for the single, composite score. For instance, recommendation engine 203 performs a look-up in the data structure to identify a listing of recommendations associated with the identified deficiency. Recommendation engine 203 then selects one of the recommendations in the listing of recommendations based on the single, composite score with a value associated with the selected recommendation. For example, the selected recommendation may be associated with a range of values between 0.22 and 0.25. If the single, composite score was 0.23, then such a recommendation would be selected since such a value is associated with the recommendation.

In one embodiment, the recommendation corresponds to a corrective action for addressing the deficiency in one of the safety categories (e.g., wayfinding, color contrast, lighting) in response to the value of the single, composite score falling below a predetermined threshold value. In one embodiment, the data structure discussed above may contain a listing of recommendations for each safety category to be performed to address the identified deficiency, where each recommendation is associated with a single, composite score being below a user-designated threshold value within a user-designated amount of variance so as to select a particular recommendation. For example, recommendation engine 203 selects one of the recommendations in the listing of recommendations based on the single, composite score being below a user-designated threshold value (e.g., 0.22) within a user-designated amount of variance (e.g., 0.01). Hence, the recommendation associated with the single, composite score being below the value of 0.22 would be selected if the single, composite score had a value of 0.215 (below the value of 0.22 within a 0.01 variance, such as 0.21), but if would not be selected if the single, composite score had a value of 0.209 (below the value of 0.22 but had a greater than a 0.01 variance).

In another example, the lighting safety category of the set of environment design rules includes ambient light levels throughout a space of the environment to ensure adequate illumination for safe navigation and potential sources of glare or shadow of the environment that cause confusion by individuals with cognitive impairment. Upon analyzing engine 202 analyzing the description of the physical characteristics of the environment against a set of environment design rules tailored for aging populations and individuals with cognitive impairment, a recommendation corresponding to a corrective action may be generated by recommendation engine 203 based on such an analysis. For example, upon identifying a deficiency in the lighting safety category, recommendation engine 203 generates a recommendation corresponding to a corrective action for adjusting a type or location of a lighting fixture to achieve a consistent, shadow-minimizing illumination in response to the single, composite being below a user-designated threshold value within a user-designated amount of variance. Such a recommendation may be identified from the data structure discussed above.

In this manner, the safety and functionality of environments for aging populations are effectively assessed and enhanced.

Furthermore, in this manner, the principles of the present disclosure provide a comprehensive, evidence-based, and easy-to-use assessment tool that can proactively identify and correct environment hazards thereby reducing injury risks and promoting the independent living and psychological well-being of aging populations, especially those with cognitive decline.

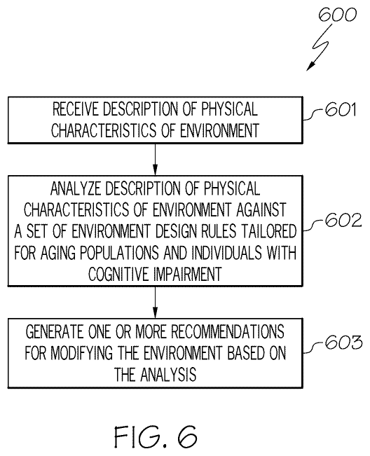

A discussion regarding the method for assessing and enhancing safety and functionality of environments for aging populations is provided below in connection with FIG. 6.

FIG. 6 is a flowchart of a method 600 for assessing and enhancing safety and functionality of environments for aging populations in accordance with an embodiment of the present disclosure.

Referring to FIG. 6, in conjunction with FIGS. 1-5, in step 601, receiving engine 201 receives a description of physical characteristics of an environment, such as an environment for aging and senior care.

As stated above, such a description, as used herein, refers to a comprehensive set of quantifiable and observable data points that define the physical, sensory, and spatial attributes of the space of the environment. In one embodiment, such a description is obtained via direct human observation/measurement (e.g., a checklist audit) or sensing technology. For example, the description of the physical characteristics may include features related to mobility, stability, and perception; data points critical for visual acuity and defining spatial boundaries; measurements impacting depth perception, shadows, and overall illumination; data used for orientation and reducing confusion; and characteristics related to comfort, accessibility, and safety.

In one embodiment, the description of the physical characteristics includes, but not limited to, the following categories: surface and flooring, color contrast and visibility, lighting conditions, wayfinding (spatial problem-solving process used by people to navigate from one location to another, relying on cognitive maps, environment cues, and directional information) and spatial organization, furnishings and fixtures.

In the category of surface and flooring, the physical characteristics include features related to mobility, stability, and perception. Examples of such physical characteristics include non-slip rating (coefficient of friction of flooring), pattern complexity (a description (e.g., solid, small, repetitive, large geometric) or a calculated metric of visual complexity, reflectivity (measurement of floor, wall, and surface gloss/sheen (potential for glare)), and transitions (presence/absence of thresholds, ramps, or changes in floor material between rooms).

In the category of color contrast and visibility, the physical characteristics include data points critical for visual acuity and defining spatial boundaries. Examples of such physical characteristics include the light reflective value (LRV), such as a measured LRV of adjacent surfaces (e.g., wall versus handrail, toilet seat versus bathroom floor, tableware versus dinning surface), and fixture visibility (color contrast ratios for essential elements (e.g., grab bars, door frames) against their background).

In the category of lighting conditions, the physical characteristics include measurements impacting depth perception, shadows, and overall illumination. Examples of such physical characteristics include ambient light levels (measured illuminance, such as in lux or foot-candles, in key areas (e.g., corridors, bedrooms, bathrooms)), shadow potential (e.g., identification of specific light sources (e.g., downlights) that create harsh or confusing shadows), and glare sources (e.g., presence of unprotected windows or highly reflective surfaces causing visual distress).

In the category of wayfinding and spatial organization, the physical characteristics include data used for orientation and reducing confusion. Examples of such physical characteristics include signage attributes (e.g., font size, color contrast, use of imagery/pictograms, and physical height/placement from the floor), landmarks (e.g., location and description of unique or recognizable features (e.g., furniture arrangement, artwork) used for cognitive mapping), and door/room identification (e.g., method of labeling doors and proximity to personalized memory cues (e.g., memory boxes)).

In the category of furnishings and fixtures, the physical characteristics include characteristics related to comfort, accessibility, and safety. Examples of such physical characteristics include handrail placement (e.g., height, diameter, and continuity of handrails in corridors and stairwells), accessibility (e.g., presence and location of grab bars in showers and near toilets), and seating contrast (e.g., color contrast of upholstery relative to the floor or surrounding walls to aid recognition).

In one embodiment, receiving engine 201 receives a description of the physical characteristics of the environment (e.g., environment for aging and senior care) through several means, including direct input, data capture, and external integration.

In one embodiment, a user (e.g., architect, facility manager, caregiver) directly enters the data (description of the physical characteristics of the environment) into computer 101.

In one embodiment, receiving engine 201 utilizes structured forms and checklists to obtain the description of the physical characteristics of the environment. For example, receiving engine 201 presents a digital form (e.g., a web application, desktop software, or mobile app) with fields corresponding to the required physical characteristics. The user manually inputs the data. For instance, a checklist for a room may include fields, such as flooring type: (dropdown: “Carpet,” “Hardwood,” “Tile”), lighting type: (dropdown: “Natural,” “Fluorescent,” “LED”), color contrast LRV: (numeric input), handrail placement: (Boolean: “Yes/No”), and doorway width: (numeric input).

In another example of utilizing structured forms and checklists to obtain the description of the physical characteristics of the environment, receiving engine 201 implements an interactive floor plan tool. For instance, the user may upload a floor plan and use an interactive overlay tool to “tag” or draw in specific features, such as handrail locations, fixture types, or areas of poor lighting.

In one embodiment, receiving engine 201 receives a description of the physical characteristics of the environment via data capture and processing. For example, receiving engine 201 utilizes image/video processing to obtain the description of the physical characteristics of the environment. For instance, in one embodiment, the user uploads photographs or video of the environment to computer 101. Receiving engine 201 then uses image recognition algorithms to identify, categorize, and measure the physical features. For example, receiving engine 201 may detect the presence of a grab bar in a bathroom, measure the color contrast between the toilet seat and the floor, or assesses the uniformity of lighting.

Another example of using data capture and processing to obtain a description of the physical characteristics of the environment is utilizing 3D scanning and building information modeling (BIM) integration. In such an embodiment, receiving engine 201 receives data directly from 3D laser scans or building information modeling (BIM) files. These files contain highly detailed, measured data on geometry, materials, and components. For example, in one embodiment, receiving engine 201 obtains precise measurements of room dimensions, wall textures, fixture locations, and window sizes via the use of a BIM model.

In one embodiment, receiving engine 201 receives a description of the physical characteristics of the environment via external data integration. In one embodiment, external data integration involves pulling existing data from outside sources or databases. For instance, in one embodiment, receiving engine 201 obtains a description of the physical characteristics of the environment via API (application programming interface) integration with design software. For example, receiving engine 201 connects to the APIs of architectural or interior design software to pull the relevant data from the design files.

Another example of using external data integration to obtain a description of the physical characteristics of the environment is utilizing sensor data. In one embodiment, receiving engine 201 receives real-time or recorded data from IoT devices, such as light meters to measure the actual light levels (lux) in various area, sound sensors to assess ambient noise for calmness criteria, and temperature/humidity sensors for comfort and safety assessment.

In one embodiment, receiving engine 201 utilizes a data ingestion module that validates and structures the incoming data into a standardized format (e.g., JSON or XML) before it is passed to analysis engine 202, which applies the set of environment design rules.

In step 602, analysis engine 202 analyzes the description of physical characteristics of the environment against a set of environment design rules tailored for aging populations and individuals with cognitive impairment.

As discussed above, the set of environment design rules, as used herein, refers to structured guidelines and criteria used to systematically arrange, specify, or modify physical and spatial characteristics of the environment to optimize its safety, functionality, accessibility, and psychological impact for a specified group (e.g., individuals living with dementia).

For example, such an analysis may involve determining a light reflective value contrast between at least two adjacent surfaces within the environment using the description of the physical characteristics of the environment. The determined light reflective value contrast is then compared against a threshold value specified in the set of environment design rules for particular features (e.g., doorways, handrails, bathroom fixtures) to identify deficiencies in visibility.

In another example, flooring characteristics in the description of the physical characteristics of the environment, including pattern complexity, reflectivity, and non-slip rating, are analyzed against the set of environment design rules. The consistency of flooring transitions across different areas of the environment to minimize perceived hazards for individuals with depth perception issues is then determined based on such an analysis.

In one embodiment, prior to analysis engine 202 performing such an analysis, the set of environment design rules tailored for aging populations and individuals with cognitive impairment is defined and structured.

In one embodiment, the “set of environment design rules” is codified based on wayfinding/visibilty, color contrast, lighting, and safety. For example, based on wayfinding/visibility, the rule category may correspond to signage and visual cues. An exemplary coded rule (logic) for such a rule category is IF Signage_Contrast_LRV<70%, THEN FAIL, where Signage_Contrast_LRV refers to the light reflective value (LRV) difference between the signage itself (e.g., letters, symbols, or graphics) and its background. An example of a failed compliance output using such a coded rule (logic) is when the signage contrast is too low for impaired vision.

In another example, the set of environment design rules is codified based on color contrast. For example, based on color contrast, the rule category may correspond to fixtures and surfaces. An exemplary coded rule (logic) for such a rule category is IF Tableware_Color≈Surface_Color THEN FAIL. Tableware_Color≈Surface_Color refers to the comparison of the color and, more critically, the light reflective value (LRV) contrast between dining items (tableware) and the surface they rest on (tabletop or tray). An example of a failed compliance output using such a coded rule (logic) is when the visual contrast between the tableware (plates, cups, bowls) and the dining surface (tabletop or placemat) is too low.

In a further example, the set of environment design rules is codified based on lighting. For example, based on lighting, the rule category may correspond to glare and shadows. An exemplary coded rule (logic) for such a rule category is IF Lighting_Uniformity≤Threshold AND Reflective_Floor=TRUE THEN FAIL. Lighting_Uniformity is a metric used to assess how evenly light is distributed across a defined area, such as a room, hallway, or walkway. Reflective_Floor=TRUE is a Boolean variable state within the analysis that indicates the floor surface of the environment being assessed is highly glossy, polished, or otherwise highly reflective. An example of a failed compliance output using such a coded rule (logic) is when there is a combination of uneven lighting and reflective flooring that creates confusing shadows/glare.

In another example, the set of environment design rules is codified based on safe flooring. For example, based on safe flooring, the rule category may correspond to flooring. An exemplary coded rule (logic) for such a rule category is IF Flooring_Pattern=“Complex” OR Flooring_Slickness≥Threshold THEN FAIL. The condition IF Flooring_Pattern=“Complex” means that analysis engine 202 is checking whether the floor surface of the environment has a visually busy, high-contrast, or non-uniform design. The condition Flooring_Slickness≥Threshold means that analysis engine 202 has determined the floor surface is too slippery (possesses a high degree of slickness or a low coefficient of friction) to be considered safe for an aging population. An example of a failed compliance output using such a coded rule (logic) is when the patterned flooring can cause visual confusion and increase fall risk.

In a further example, the set of environment design rules is codified based on bathroom safety. For example, based on bathroom safety, the rule category may correspond to fixtures. An exemplary coded rule (logic) for such a rule category is IF Grab_Bars_Present=FALSE OR Toilet_Seat_Contrast=Low THEN FAIL. The condition IF Grab_Bars_Present=FALSE means analysis engine 202 has determined that grab bars are not installed or are not present in the bathroom area of the environment being assessed. The condition Toilet Seat_Contrast=Low means analysis engine 202 has determined there is insufficient visual contrast between the toilet seat and the surrounding area, particularly the toilet bowl or the wall behind it. An example of a failed compliance output using such a coded rule (logic) is when there are missing grab bars or a high-contrast toilet seat is needed for visibility.

In one embodiment, analysis engine 202 processes the received description (from forms, BIM, or sensors) and normalizes it into standardized data variables (e.g., Signage_Contrast_LRV, Doorway_Width, Lighting_Uniformity). Analysis engine 202 then runs the standardized input data through every relevant coded rule in the “set of environment design rules.” In one embodiment, each rule check results in an outcome (e.g., pass, fail, caution) and an associated score for that element. In one embodiment, analysis engine 202 aggregates these scores to create a sectional safety score (e.g., a wayfinding score, a bathroom safety score) and an overall compliance score.

In one embodiment, after codifying the design rules, analysis engine 202 performs the analysis of the description of the physical characteristics of the environment against the set of environment design rules tailored for aging populations and individuals with cognitive impairment in two stages, namely data mapping and calculation as well as rule comparison and scoring.

In one embodiment, data mapping and calculation involves analysis engine 202 mapping the received data (description of the physical characteristics) to the standardized variables used in the rules. For example, analysis engine 202 maps the measured LRVs of the sign and the background to calculate the Signage_Contrast_LRV.

In one embodiment, rule comparison and scoring involves analysis engine 202 running the standardized variables through the coded rules. In one embodiment, analysis engine 202 performs iterative checks. For example, analysis engine 202 performs a systematic check for every rule. If the input data violates a rule, then that element receives a “fail” status.

Furthermore, in one embodiment, rule comparison and scoring involves analysis engine 202 generating a compliance score. For example, based on the number and severity of “fails,” analysis engine 202 calculates a compliance score and individual scores for the categories (e.g., a “wayfinding score”).

Additionally, in one embodiment, rule comparison and scoring involves analysis engine 202 performing hazard identification. For example, analysis engine 202 identifies where confusing shadows/glare (e.g., lighting/reflective flooring), visual confusion (e.g., patterned flooring), and fall risks (e.g., slickness/missing grab bars) exist in the environment.

In one embodiment, analysis engine 202 assigns a weighted score to the environment for each safety category (e.g., wayfinding, color contrast, and lighting) based on a predefined weighting scheme derived from clinical or design research. In one embodiment, analysis engine 202 calculates a single, composite score by aggregating the weighted score. As discussed further below, recommendation engine 203 generates a recommendation(s) for modifying the environment based on the single, composite score.

In one embodiment, analysis engine 202 defines the metrics within the safety categories (e.g., wayfinding, color contrast, lighting). For example, for the wayfinding safety category, the metrics of the number of clear signage locations, clarity index of directional text, logical flow score, etc. are measured. In another example, for the color contrast safety category, the average luminance contrast ratio of key elements (e.g., floor to wall), color difference score, etc. are measured. In a further example, for the lighting safety category, the average illuminance (lux) levels in key areas, uniformity ratio, glare rating, etc. are measured.

In one embodiment, each of these metrics is associated with a defined measurement scale and a target/ideal value.

In one embodiment, analysis engine 202 standardizes/normalizes the raw scores. For example, analysis engine 202 converts the raw measurement score (e.g., illuminance=500 lux) from the environment into a standardized score (e.g., 0 to 1 or 0 to 100), where a higher score indicates better performance relative to the ideal. For example, with respect to color contrast, if the ideal LCR is 7:1 or higher, and the minimum acceptable is 3:1, a function may be utilized to assign 100 for 7:1 and above, 0 for 3:1 and below, and scales linearly in between.

In another example, with respect to lighting, if the target illuminance is 500 lux, a deviation of +100 lux might result in a score reduction.

In one embodiment, this standardization results in a category metric score (Sₘ) for each metric, ranging from [0, 1] or [0, 100].

In one embodiment, analysis engine 202 calculates a score for each main safety category by aggregating the scores of its constituent metrics using predefined internal weights (wₘ). In one embodiment, the category score (CS_{c}) for category c is the weighted average of its metric scores (S_{m,i})

$${CS}_{c} = \frac{{\sum }_{i = 1}^{n} ( {S}_{m , i} \cdot {w}_{m , i} )}{{\sum }_{i = 1}^{n} {w}_{m , i}}$$

For example, in the wayfinding category, if the number of clear signage locations is considered twice as important as the clarity index, its weight (wₘ) would be 2 and the other 1.

In one embodiment, the predefined weighting scheme assigns an external weight (W_{c}) to each category, derived from clinical or design research. These weights reflect the relative importance of each category to overall safety. For example, the wayfinding safety category may be assigned the weight (W_{c}) of 0.35 based on studies on cognitive decline and disorientation. Furthermore, the color contrast safety category may be assigned the weight (W_{c}) of 0.45 based on vision impairment and fall prevention research. In another example, the lighting safety category may be assigned the weight (W_{c}) of 0.20 based on research on visual acuity and depression in aging.

In one embodiment, analyzing engine 202 calculates the weighted score for the environment for each safety category:

$$Weighted Score = {CS}_{c} \cdot {W}_{c}$$

In one embodiment, analysis engine 202 aggregates the weighted scores from all categories to calculate the final composite score (CompS). In one embodiment, the final composite score is a single number that represents the environment's overall safety rating.

$$CompS = {\sum }_{c = 1}^{k} Weighted {Score}_{c} = {\sum }_{c = 1}^{k} ( {CS}_{c} \cdot {W}_{c} )$$

In one embodiment, both the category scores (CS_{c}) and the final composite score are on a [0, 100] scale. In such an embodiment, a score of 95, for example, means the environment meets 95% of the weighted safety criteria.

In one embodiment, analysis engine 202 utilizes the following key design principles and features that form the foundation of the tool of the present disclosure, which reduces injury risks and promotes the independent living and psychological well-being of aging populations, especially those with cognitive decline. Such principles and features form the ruleset and assessment criteria used by analysis engine 202 for translating research on gerontology, vision impairment, and dementia care into actionable design standards. The approach is holistic, covering the environment from the macro level (wayfinding) to the micro level (tableware contrast).

In one embodiment, one key design principle and feature is safety and visibility through contrast. For example, high visual contrast is used to compensate for age-related and cognitive visual impairments. Examples of safety and visibility through contrast include color contrast and visibility, which mandates clear distinctions between objects to prevent confusion. For instance, analyzing engine 202 analyzes the physical characteristics of the environment against the set of environment design rules to ensure a user-designated high contrast between tableware and surfaces to aid recognition during dining and ensures essential features, such as handrails and door frames, are clearly visible against their backgrounds.

An example of color contrast enhancements used to emphasize the contrast between tableware and surfaces to aid recognition during dining is shown in FIG. 3.

Another example of safety and visibility through contrast includes wayfinding and navigation. For example, contrast may be optimized by requiring a minimum light reflective value (LRV) difference for key features, such as signage and doorways. As a result, analyzing engine 202 analyzes the physical characteristics of the environment against the set of environment design rules to ensure such a minimum LRV difference for key features is obtained. In another example, signage may be positioned at eye level (from the ground) and include large font sizes for maximum legibility As a result, analyzing engine 202 analyzes the physical characteristics of the environment against the set of environment design rules to ensure that the signage is appropriate. An example of wayfinding signage being used to promote safety and visibility through contrast is provided in FIG. 4.

A further example of safety and visibility through contrast includes handrails and stair safety. Handrails need to be in clear contrast with surrounding walls, and color strips are used on stairs to signal level transitions, both aimed at assisting orientation and preventing falls. As a result, analyzing engine 202 analyzes the physical characteristics of the environment against the set of environment design rules to ensure that handrails are in clear contrast with surrounding walls and that color strips are used on stairs to signal level transitions.

In one embodiment, another key design principle and feature is fall prevention and environment clarity. Such a principle focuses on mitigating physical hazards and reducing visual confusion that leads to falls. For example, analyzing engine 202 analyzes the physical characteristics of the environment against the set of environment design rules to ensure safe flooring and pathways. Such an analysis is important for preventing falls by individuals by ensuring that the flooring be non-slip, pattern-free, and non-reflective. Furthermore, by ensuring that the flooring is pattern-free and non-reflective, this avoids visual confusion, which is often caused when shiny or patterned surfaces are misinterpreted as water, holes, or uneven ground by individuals with dementia.

In another embodiment, fall prevention and environment clarity is achieved by analyzing engine 202 analyzing the physical characteristics of the environment against the set of environment design rules to ensure lighting is appropriate. For example, analyzing engine 202 analyzes the physical characteristics of the environment against the set of environment design rules to ensure there is consistent, natural lighting thereby promoting safe navigation by eliminating the shadows that confuse individuals with depth perception issues. It also stresses that glare should be minimized, directly linking lighting quality to safety.

In another embodiment, fall prevention and environment clarity is achieved by analyzing engine 202 analyzing the physical characteristics of the environment against the set of environment design rules to ensure adequate bathroom safety. For example, analyzing engine 202 combines contrast with accessibility to ensure adequate bathroom safety, such as ensuring there are grab bars (e.g., grab bars in showers and near toilets) and non-slip flooring while also ensuring contrasting toilet seats to enhance fixture visibility.

In one embodiment, another key design principle and feature is cognitive and emotional support. Such a design rule addresses the psychological impact of the environment for individuals, such as individuals with dementia. For example, analyzing engine 202 analyzes the physical characteristics of the environment against the set of environment design rules to ensure comfort and reducing anxiety by ensuring the existence of memory aids and personalization. Such a principle emphasizes integrating personalized visual cues, such as memory boxes or personal photographs near doorways, to assist with orientation and memory recall thereby increasing comfort and reducing anxiety. For example, analyzing engine 202 may ensure that a memory box, which may be personalized with an individual's family photographs and memorabilia, is placed near a doorway to assist the individual with orientation and memory recall. An example of the placement of memory boxes near a doorway to assist individuals (individuals with personalized memories contained in such memory boxes) with memory recall is provided in FIG. 5.

In another embodiment, cognitive and emotional support is achieved by analyzing engine 202 analyzing the physical characteristics of the environment against the set of environment design rules to ensure calmness. For example, analyzing engine 202 analyzes the physical characteristics of the environment against the set of environment design rules to ensure calmness in the environment, such as ensuring that calming, soft colors (e.g., warm white or cool blue colors) are used on the walls to reduce agitation and create a soothing atmosphere based on the direct link between the environment and psychological well-being.

As a result of implementing such design principles and features, the principles of the present disclosure provide a comprehensive, evidence-based, and highly specialized system that moves beyond general safety checklists to provide quantifiable, actionable design guidance tailored precisely to the unique cognitive and physical needs of the aging population.

In step 603, recommendation engine 203 generates one or more recommendations for modifying the environment based on the analysis performed by analyzing engine 202, where the recommendations enhance safety and functionality of the environment by adjusting wayfinding elements, visual cues, color contrast and visibility, and/or lighting conditions. For instance, a recommendation may be directed to adjusting a type or location of a lighting fixture to achieve a consistent, shadow-minimizing illumination.

As stated above, in one embodiment, such recommendations are actionable insights designed to enhance the environment's safety, accessibility, and functionality. They translate the identified deficiencies (e.g., poor color contrast, inadequate lighting, complex flooring) into concrete, practical corrective actions.

In one embodiment, the modifications to the environment are specifically aimed at adjusting key environment factors, such as wayfinding elements, visual cues and memory aids, color contrast and visibility, lighting conditions, and flooring and pathways. For example, with respect to wayfinding elements, recommendation engine 203 generates a recommendation for high-contrast, appropriately sized, and well-placed signage (e.g., positioned at eye level, using a minimum light reflective value (LRV) contrast of 70% for visibility). In another example, with respect to visual cues and memory aids, recommendation engine 203 generates a recommendation for the strategic placement of personalized cues, such as memory boxes or personal photographs, at specific locations, such as doorways, within the environment to assist with orientation and memory recall. In a further example, with respect to color contrast and visibility, recommendation engine 203 generates a recommendation to ensure a high contrast between essential features and their background (e.g., between handrails and walls, tableware and surfaces, or toilet seats and bathroom floors) to aid recognition for individuals with vision or cognitive impairment. In another example, with respect to lighting conditions, recommendation engine 203 generates a recommendation for adjusting the type or location of lighting fixtures to achieve consistent, natural, and shadow-minimizing illumination while also minimizing glare. In a further example, with respect to flooring and pathways, recommendation engine 203 generates a recommendation for using non-slip, non-reflective, and pattern-free flooring, and corrective actions to ensure consistent floor transitions to minimize perceived fall hazards. In another example, with respect to targeted corrective action, when the analysis involves assigning weighted scores and calculating a composite score, recommendation engine 203 generates a recommendation that includes a specific corrective action corresponding to any safety category (wayfinding, color contrast/lighting) that falls below a predetermined safety threshold. In a further example, with respect to proactive hazard prevention, recommendation engine 203 generates a proactive recommendation which identifies potential hazards in the physical space before an accident occurs thereby directly contributing to the intended purpose of reducing fall-related incidents and confusion in the aging population.

In one embodiment, recommendation engine 203 uses the analysis data from analysis engine 203 to formulate recommendations within specified constraints. In one embodiment, recommendation engine 203 identifies deficiencies. For example, recommendation engine 203 scans the analysis to pinpoint areas that fall short of established safety/accessibility standards (e.g., ADA guidelines, building codes, industry best practices) or operational goals (e.g., minimizing errors, speeding up task completion). For example, the analysis performed by analysis engine 202 indicates a low lex level in the main corridor.

In one embodiment, for each identified deficiency, recommendation engine 203 identifies the recommendation to address the identified deficiency based on performing a look-up in a data structure (e.g., table) that contains a listing of recommendations based on identified deficiencies. Upon identifying the deficiency, recommendation engine 203 performs a look-up in the data structure to identify the recommendation associated with the identified deficiency. In one embodiment, such a data structure is populated by an expert (e.g., administrator, architect, interior designer, facility manager). In one embodiment, the data structure resides within the storage device (e.g., storage device 113, 115) of computer 101.

In one embodiment, recommendation engine 203 generates a specific, quantifiable action that directly addresses the deficiency using one of the allowed adjustments to enhance safety and functionality. For example, recommendation engine 203 generates a recommendation that increases the lighting condition in the main corridor to a uniform lux level by replacing existing fixtures with higher-output LED panels (enhances functionality for task visibility and safety by reducing tripping hazards).

In one embodiment, as discussed above, recommendation engine 203 generates a recommendation(s) for modifying the environment based on the single, composite score. For example, the data structure discussed above may contain a listing of recommendations to be performed to address the identified deficiency, where each recommendation is associated with a range of values for the single, composite score. For instance, recommendation engine 203 performs a look-up in the data structure to identify a listing of recommendations associated with the identified deficiency. Recommendation engine 203 then selects one of the recommendations in the listing of recommendations based on the single, composite score with a value associated with the selected recommendation. For example, the selected recommendation may be associated with a range of values between 0.22 and 0.25. If the single, composite score was 0.23, then such a recommendation would be selected since such a value is associated with the recommendation.

In one embodiment, the recommendation corresponds to a corrective action for addressing the deficiency in one of the safety categories (e.g., wayfinding, color contrast, lighting) in response to the value of the single, composite score falling below a predetermined threshold value. In one embodiment, the data structure discussed above may contain a listing of recommendations for each safety category to be performed to address the identified deficiency, where each recommendation is associated with a single, composite score being below a user-designated threshold value within a user-designated amount of variance so as to select a particular recommendation. For example, recommendation engine 203 selects one of the recommendations in the listing of recommendations based on the single, composite score being below a user-designated threshold value (e.g., 0.22) within a user-designated amount of variance (e.g., 0.01). Hence, the recommendation associated with the single, composite score being below the value of 0.22 would be selected if the single, composite score had a value of 0.215 (below the value of 0.22 within a 0.01 variance, such as 0.21), but if would not be selected if the single, composite score had a value of 0.209 (below the value of 0.22 but had a greater than a 0.01 variance).

In another example, the lighting safety category of the set of environment design rules includes ambient light levels throughout a space of the environment to ensure adequate illumination for safe navigation and potential sources of glare or shadow of the environment that cause confusion by individuals with cognitive impairment. Upon analyzing engine 202 analyzing the description of the physical characteristics of the environment against a set of environment design rules tailored for aging populations and individuals with cognitive impairment, a recommendation corresponding to a corrective action may be generated by recommendation engine 203 based on such an analysis. For example, upon identifying a deficiency in the lighting safety category, recommendation engine 203 generates a recommendation corresponding to a corrective action for adjusting a type or location of a lighting fixture to achieve a consistent, shadow-minimizing illumination in response to the single, composite being below a user-designated threshold value within a user-designated amount of variance. Such a recommendation may be identified from the data structure discussed above.

As a result of the foregoing, the safety and functionality of environments for aging populations are effectively assessed and enhanced.

Furthermore, as a result of the foregoing, the principles of the present disclosure provide a comprehensive, evidence-based, and easy-to-use assessment tool that can proactively identify and correct environment hazards thereby reducing injury risks and promoting the independent living and psychological well-being of aging populations, especially those with cognitive decline.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for assessing and enhancing safety and functionality of environments for aging populations, the method comprising:
receiving a description of physical characteristics of an environment;
analyzing said description of physical characteristics of said environment against a set of environment design rules tailored for aging populations and individuals with cognitive impairment, wherein said set of environment design rules is structured guidelines and criteria used to systematically arrange, specify, or modify physical and spatial characteristics of said environment to optimize its safety, functionality, accessibility, and psychological impact for a specified group; and
generating one or more recommendations for modifying said environment based on said analysis, wherein said one or more recommendations enhance safety and functionality of said environment by adjusting one or more of the following: wayfinding elements, visual cues, color contrast and visibility, and lighting conditions.

2. The method as recited in claim 1, wherein said analysis of said description of physical characteristics of said environment against said set of environment design rules tailored for aging populations and individuals with cognitive impairment comprises:
determining a light reflective value contrast between at least two adjacent surfaces within said environment; and
comparing said determined light reflective value contrast against a threshold value specified in said set of environment design rules for features to identify deficiencies in visibility, wherein said features comprise one or more of the following: doorways, handrails, and bathroom fixtures.

3. The method as recited in claim 1, wherein said one or more recommendations comprise a recommendation for placement of personalized memory cues at a specific location within said environment.

4. The method as recited in claim 1, wherein said analysis of said description of physical characteristics of said environment against said set of environment design rules tailored for aging populations and individuals with cognitive impairment comprises:
analyzing flooring characteristics in said description of physical characteristics of said environment including pattern complexity, reflectivity, and non-slip rating, against said set of environment design rules; and
determining consistency of flooring transitions across different areas of said environment to minimize perceived hazards for individuals with depth perception issues based on said analysis of said flooring characteristics against said set of environment design rules.

5. The method as recited in claim 1, wherein said set of environment design rules is directed to safety categories of wayfinding, color contrast and lighting, wherein said analysis of said description of physical characteristics of said environment against said set of environment design rules tailored for aging populations and individuals with cognitive impairment comprises:
assigning a weighted score to said environment for each safety category based on a predefined weighting scheme derived from clinical or design research;
calculating a single, composite score by aggregating said weighted scores; and
generating said one or more recommendations for modifying said environment based on said single, composite score.

6. The method as recited in claim 5, wherein said one or more recommendations comprise a corrective action for addressing a deficiency in one of said safety categories in response to a value of said single, composite score falling below a threshold value within a user-designated variance.

7. The method as recited in claim 5, wherein said lighting safety category of said set of environment design rules comprises ambient light levels throughout a space of said environment to ensure adequate illumination for safe navigation and potential sources of glare or shadow of said environment that cause confusion by individuals with cognitive impairment, wherein said one or more recommendations comprise a corrective action for adjusting a type or location of a lighting fixture to achieve a consistent, shadow-minimizing illumination.

8. A computer program product for assessing and enhancing safety and functionality of environments for aging populations, the computer program product comprising one or more computer readable storage mediums having program code embodied therewith, the program code comprising programming instructions for:
receiving a description of physical characteristics of an environment;
analyzing said description of physical characteristics of said environment against a set of environment design rules tailored for aging populations and individuals with cognitive impairment, wherein said set of environment design rules is structured guidelines and criteria used to systematically arrange, specify, or modify physical and spatial characteristics of said environment to optimize its safety, functionality, accessibility, and psychological impact for a specified group; and
generating one or more recommendations for modifying said environment based on said analysis, wherein said one or more recommendations enhance safety and functionality of said environment by adjusting one or more of the following: wayfinding elements, visual cues, color contrast and visibility, and lighting conditions.

9. The computer program product as recited in claim 8, wherein said analysis of said description of physical characteristics of said environment against said set of environment design rules tailored for aging populations and individuals with cognitive impairment comprises:
determining a light reflective value contrast between at least two adjacent surfaces within said environment; and
comparing said determined light reflective value contrast against a threshold value specified in said set of environment design rules for features to identify deficiencies in visibility, wherein said features comprise one or more of the following: doorways, handrails, and bathroom fixtures.

10. The computer program product as recited in claim 8, wherein said one or more recommendations comprise a recommendation for placement of personalized memory cues at a specific location within said environment.

11. The computer program product as recited in claim 8, wherein said analysis of said description of physical characteristics of said environment against said set of environment design rules tailored for aging populations and individuals with cognitive impairment comprises:
analyzing flooring characteristics in said description of physical characteristics of said environment including pattern complexity, reflectivity, and non-slip rating, against said set of 5 environment design rules; and
determining consistency of flooring transitions across different areas of said environment to minimize perceived hazards for individuals with depth perception issues based on said analysis of said flooring characteristics against said set of environment design rules.

12. The computer program product as recited in claim 8, wherein said set of environment design rules is directed to safety categories of wayfinding, color contrast and lighting, wherein said analysis of said description of physical characteristics of said environment against said set of environment design rules tailored for aging populations and individuals with cognitive impairment comprises:
assigning a weighted score to said environment for each safety category based on a predefined weighting scheme derived from clinical or design research;
calculating a single, composite score by aggregating said weighted scores; and
generating said one or more recommendations for modifying said environment based on said single, composite score.

13. The computer program product as recited in claim 12, wherein said one or more recommendations comprise a corrective action for addressing a deficiency in one of said safety categories in response to a value of said single, composite score falling below a threshold value within a user-designated variance.

14. The computer program product as recited in claim 12, wherein said lighting safety category of said set of environment design rules comprises ambient light levels throughout a space of said environment to ensure adequate illumination for safe navigation and potential sources of glare or shadow of said environment that cause confusion by individuals with cognitive impairment, wherein said one or more recommendations comprise a corrective action for adjusting a type or location of a lighting fixture to achieve a consistent, shadow-minimizing illumination.

15. A system, comprising:
a memory for storing a computer program for assessing and enhancing safety and functionality of environments for aging populations; and
a processor connected to the memory, wherein the processor is configured to execute program instructions of the computer program comprising:
receiving a description of physical characteristics of an environment;
analyzing said description of physical characteristics of said environment against a set of environment design rules tailored for aging populations and individuals with cognitive impairment, wherein said set of environment design rules is structured guidelines and criteria used to systematically arrange, specify, or modify physical and spatial characteristics of said environment to optimize its safety, functionality, accessibility, and psychological impact for a specified group; and
generating one or more recommendations for modifying said environment based on said analysis, wherein said one or more recommendations enhance safety and functionality of said environment by adjusting one or more of the following: wayfinding elements, visual cues, color contrast and visibility, and lighting conditions.

16. The system as recited in claim 15, wherein said analysis of said description of physical characteristics of said environment against said set of environment design rules tailored for aging populations and individuals with cognitive impairment comprises:
determining a light reflective value contrast between at least two adjacent surfaces within said environment; and
comparing said determined light reflective value contrast against a threshold value specified in said set of environment design rules for features to identify deficiencies in visibility, wherein said features comprise one or more of the following: doorways, handrails, and bathroom fixtures.

17. The system as recited in claim 15, wherein said one or more recommendations comprise a recommendation for placement of personalized memory cues at a specific location within said environment.

18. The system as recited in claim 15, wherein said analysis of said description of physical characteristics of said environment against said set of environment design rules tailored for aging populations and individuals with cognitive impairment comprises:
analyzing flooring characteristics in said description of physical characteristics of said environment including pattern complexity, reflectivity, and non-slip rating, against said set of environment design rules; and
determining consistency of flooring transitions across different areas of said environment to minimize perceived hazards for individuals with depth perception issues based on said analysis of said flooring characteristics against said set of environment design rules.

19. The system as recited in claim 15, wherein said set of environment design rules is directed to safety categories of wayfinding, color contrast and lighting, wherein said analysis of said description of physical characteristics of said environment against said set of environment design rules tailored for aging populations and individuals with cognitive impairment comprises:
assigning a weighted score to said environment for each safety category based on a predefined weighting scheme derived from clinical or design research;
calculating a single, composite score by aggregating said weighted scores; and
generating said one or more recommendations for modifying said environment based on said single, composite score.

20. The system as recited in claim 19, wherein said one or more recommendations comprise a corrective action for addressing a deficiency in one of said safety categories in response to a value of said single, composite score falling below a threshold value within a user-designated variance.
